(19) United States
(12) Patent Application Publication
(10) Pub. No.: US 2025/0009175 A1
(43) Pub. Date: Jan. 9, 2025

(54) COOKING STATION WITH MULTIPLE COOKING MODES AND METHOD THEREOF

(71) Applicant: North Atlantic Imports, LLC, Logan, UT (US)

(72) Inventors: Adam S. Dexter, Wellsville, UT (US); Vivian Pham, Logan, UT (US); Ryan D. Tirrell, North Logan, UT (US); James C. Bush, III, Providence, UT (US); Tyler J. Fullmer, Smithfield, UT (US)

(21) Appl. No.: 18/751,128

(22) Filed: Jun. 21, 2024

Related U.S. Application Data
(63) Continuation-in-part of application No. 17/887,024, filed on Aug. 12, 2022.
Application No. 17/887,024 is a continuation-in-part of application No. 17/407,704, filed on Aug. 20, 2021, now Pat. No. 11,700,971.
Application No. 17/407,704 is a continuation of application No. 16/428,605, filed on May 31, 2019, now Pat. No. 11,116,360.
(60) Provisional application No. 63/615,077, filed on Dec. 27, 2023.
(60) Provisional application No. 63/522,376, filed on Jun. 21, 2023.
(60) Provisional application No. 63/232,630, filed on Aug. 12, 2021.
(60) Provisional application No. 62/678,436, filed on May 31, 2018.

(51) Int. Cl. A47J 37/07; A23B 4/052; A23L 5/10; A47J 37/06

(52) U.S. Cl. CPC A47J 37/0713; A23B 4/052; A23L 5/15; A47J 37/0682; A47J 37/0709; A23V 2002/00

(57) ABSTRACT

An outdoor cooking station configured to simultaneously and independently cook food with different fuel or energy sources. The cooking station including a main body extending with a framework and panels to define a griddle portion and an oven portion. The griddle portion includes a griddle supported by an upper side of the main body, the griddle positioned above one or more gas flame burners supported by the main body. The oven portion is positioned below the griddle portion such that the oven portion includes chamber panels defining a chamber of the oven portion, the oven portion heated with electrical heating elements positioned below and above a cooking surface within the chamber and a fan positioned above the cooking surface for mixing the air within the chamber.

### CROSS-REFERENCE TO RELATED APPLICATIONS

The present application claims the benefit of U.S. Provisional Application No. 63/615,077, filed Dec. 27, 2023, and claims benefit of U.S. Provisional Application No. 63/522,376, filed Jun. 21, 2023, the disclosures of which are hereby incorporated by reference herein in their entirety. Further, the present application is a continuation-in-part of U.S. patent application Ser. No. 17/887,024, filed Aug. 12, 2022, which claims the benefit of U.S. Provisional Application No. 63/232,630, filed Aug. 12, 2021, the disclosures of which are hereby incorporated by reference herein in their entirety. Further, U.S. application Ser. No. 17/887,024 is a continuation-in-part 17/407,704, filed Aug. 20, 2021, now U.S. Pat. No. 11,700,971, which is a continuation of U.S. patent application Ser. No. 16/428,605, filed May 31, 2019, now U.S. Pat. No. 11,116,360, which claims the benefit of U.S. Provisional Application No. 62/678,436, filed May 31, 2018, the disclosures of which are hereby incorporated by reference herein in their entirety.

### TECHNICAL FIELD

The present invention relates generally to cooking systems and, more specifically, the present invention relates to cooking systems with multiple cooking modes within a single stand-alone cooking station.

### BACKGROUND

The ability to cook outdoors has become more attainable and popular as it can be utilized in multiple settings such as backyards, parks, camping, and tailgating and, as popularity has increased, outdoor cooking technology continues to adapt and improve. The typical outdoor foods such as hamburgers, hot dogs, or grilled chicken are no longer the typical option as indoor cooking appliances have adapted to be utilized outdoors such that a variety of foods may be cooked in outdoor settings. However, as the types of food desired to be cooked in the outdoors has diversified, two or more cooking stations may be needed to cook the different types of food. If two or more cooking stations are needed for users to cook the desired types of food, then this may pose issues of backyard porch space or the like and such cooking stations are often bulky, heavy and may not be readily moveable to various locations.

### BRIEF SUMMARY OF THE INVENTION

The present invention is directed to various embodiments of an outdoor cooking station configured to simultaneously and independently cook food with separate cooking modes. In one embodiment, the outdoor cooking station includes a main body with a griddle portion and an oven portion. The griddle portion includes a griddle member supported by the main body and positioned above one or more gas flame burners. The oven portion is positioned below the griddle portion, the oven portion including multiple panels positioned to define a cooking chamber with an access member positioned along a front side of the cooking chamber. The access member is configured to be moveable between open and closed positions. The cooking chamber includes a lower electrical heating element, a plate, an upper electrical heating element, and a fan. The lower electrical heating element is positioned below the plate and the upper electrical heating element is positioned above the plate with the fan positioned above the upper electrical heating element. With this arrangement, the fan is configured to move air over the upper electrical heating element and mix the air within the cooking chamber.

In another embodiment, the multiple panels act as a first heat shield relative to an exterior wall structure of the main body. In another embodiment, the outdoor cooking station further includes a secondary heat shield, the secondary heat shield at least partially positioned between the exterior wall structure and the multiple panels that define the cooking chamber. In another embodiment, the outdoor cooking station further includes a secondary heat shield and an insulation material, the secondary heat shield configured to at least partially surround the first heat shield with the insulation material positioned between the secondary heat shield and the first heat shield.

In another embodiment, the plate extends to define a metal flat cooking surface of the oven portion. In another embodiment, the plate is configured to support a basket type container thereon, the basket type container configured to hold food therein and configured to be positioned within the cooking chamber and removed from the cooking chamber. In another embodiment, the main body defines storage structure positioned along one side of the multiple panels of the cooking chamber. In another embodiment, the outdoor cooking station further includes an upper fan configured to cool the motor of the fan positioned adjacent the upper electrical heating element. In another embodiment, the outdoor cooking station further includes a lower ventilation portion positioned below the gas flame burners, the lower ventilation portion positioned above an upper venting portion of the oven portion.

In accordance with another embodiment of the present invention, an outdoor cooking station configured to simultaneously and independently cook food with separate cooking modes is provided. The outdoor cooking station includes a main body, a griddle portion and an oven portion. The main body extends with a framework and panels positioned to define a front side, a rear side, a left side and a right side, the main body including one or more gas flame burners controlled along the front side and coupled to the main body. The griddle portion includes a griddle supported by an upper side of the main body, the griddle positioned above the one or more gas flame burners of the main body. The oven portion is positioned below the griddle portion of the main body, the oven portion defined with the framework and the panels of the main body, the oven portion including chamber panels defining a chamber of the oven portion. Further, the oven portion includes a lower electrical heating element, a plate, an upper electrical heating element, and a fan. The plate is positioned above the lower heating element, the plate including a flat cooking surface. The upper electrical heating element is positioned above the plate. The fan is positioned above the upper electrical heating element, the fan configured to move air over the upper heating element and configured to mix air within the chamber. With this arrangement, the lower and upper electrical heating elements are associated with and controlled by a control knob positioned along a front side of the oven portion.

In another embodiment, the oven portion includes two heat shields surrounding the chamber and separated with a spaced gap to minimize temperature of an exterior surface of the panels of the main body. In another embodiment, the two heat shields include an insulation material positioned within the spaced gap between the two heat shields. In another embodiment, the plate is configured to support a basket type container thereon, the basket type container configured to hold food therein and configured to be positioned within the chamber and removed from the chamber.

In another embodiment, the main body defines storage structure positioned along one side of the chamber. In another embodiment, the oven portion further includes an upper fan configured to cool the motor of the fan positioned adjacent the upper electrical heating element. In another embodiment, the outdoor cooking station further includes a lower ventilation portion positioned below the gas flame burners, the lower ventilation portion positioned above an upper venting portion of the oven portion. In another embodiment, the oven portion includes a front door pivotably coupled to chamber panels to facilitate access to the chamber of the oven portion.

In accordance with another embodiment of the present invention, a method for cooking food in the outdoors is provided. The method steps include: providing a main body extending with a framework and panels positioned to define a front side, a rear side, a left side and a right side, the main body including one or more gas flame burners controlled along the front side and coupled to the main body, the main body including a griddle portion and an oven portion, the griddle portion including a griddle supported by an upper side of the main body, the griddle positioned above the one or more gas flame burners of the main body, the oven portion positioned directly below the griddle portion of the main body, the oven portion defined with the framework and the panels of the main body, the oven portion including chamber panels defining a chamber of the oven portion, the oven portion including a lower electrical heating element, a plate positioned above the lower electrical heating element, the plate including a cooking surface, an upper electrical heating element positioned above the plate, and a fan positioned above the upper electrical heating element, the fan configured to move air over the upper electrical heating element and configured to mix air within the chamber; opening an access member to position food over the cooking surface of the plate and closing the access member to enclose the food within the chamber of the oven portion; heating the chamber with at least one of the lower electrical heating element and the upper electrical heating element; and heating the griddle of the griddle portion with the gas flame burners for cooking other food on the griddle while simultaneously cooking the food positioned over the cooking surface of the plate within the chamber of the oven portion.

In another embodiment, the method further includes rotating the plate while heating the chamber to assist in even cooking of the food positioned over the plate in the chamber of the oven portion. In another embodiment, the heating the chamber step includes controlling the heating with pre-set controls selectable from a control knob along an external surface of the oven portion of the main body. In another embodiment, the heating the chamber step includes mixing air within the chamber with the fan. In another embodiment, the heating the chamber step includes retaining heat in the chamber with insulation material positioned around the panels defining the chamber and with a heat shield at least partially surrounding the insulation material.

In accordance with another embodiment of the present invention, a portable oven with multiple cooking modes is provided. The portable oven includes a main body, a plate, an upper electric heating member, a lower electric heating member, and a fan. The main body extends to include a front side wall, a rear side wall, a left side wall, and a right side wall each extending to an upper side wall and lower side wall. The main body extends to define a cooking chamber therein, the front side wall including a front door positioned thereon configured to provide access to the cooking chamber. The plate is positioned within the cooking chamber, the plate including a flat cooking surface and configured to rotate within the cooking chamber. The upper electric heating member and the lower electric heating member are positioned within the main body, the upper electric heating member positioned adjacent an upper side of the cooking chamber and the lower electric heating member positioned below the plate. The fan is positioned between the upper side wall and the upper electric heating member, the fan configured to mix air within the cooking chamber and to move air through the upper electric heating member.

In another embodiment, the flat cooking surface of the plate is a metal surface. In another embodiment, the flat cooking surface of the plate is a cast iron surface. In another embodiment, the upper side wall of the main body includes an upper door positioned thereon, the upper door positioned against one end of the front door, upon the front door and the upper door being in the closed position. In another embodiment, upon the front door being in an open position, the front side of the main body defines a first chamber opening size, and upon the front door and the upper door being in an open position, the front side and the upper side of the main body defines a second chamber opening size, the second chamber opening size being larger than the first chamber opening size.

In another embodiment, the portable oven further includes a tray with an upstanding side wall, the tray sized and configured to be positioned on the flat cooking surface of the plate. In another embodiment, the portable oven further includes a wire basket configured to be positioned within the tray. In another embodiment, the portable oven further includes a crumb tray, the crumb tray removable from the main body and positionable adjacent the lower side wall of the main body. In another embodiment, upon the portable oven being in a pizza oven mode, at least one of the upper and lower electric heating members are activated to heat the cooking chamber and, upon the portable oven being in an air frying mode, the upper electric heating member and the fan are activated to heat the cooking chamber.

### BRIEF DESCRIPTION OF THE SEVERAL VIEWS OF THE DRAWINGS

The foregoing and other advantages of the invention will become apparent upon reading the following detailed description and upon reference to the drawings in which:

FIG. 1 is an upper perspective view of a portable oven, according to an embodiment of the present invention;

FIG. 2 is a lower perspective view of the portable oven, depicting a wide chamber opening to a cooking chamber of the portable oven, according to another embodiment of the present invention;

FIG. 3 is an upper perspective view of the portable oven, depicting a narrow chamber opening to the cooking chamber of the portable oven, according to another embodiment of the present invention;

FIG. 4 is an exploded view of the portable oven, according to another embodiment of the present invention;

FIG. 5 is perspective view of the portable oven, depicting a crumb tray removed from the cooking chamber of the portable oven, according to another embodiment of the present invention;

FIG. 6 is a cross-sectional view of the portable oven taken along section line 6-6 of FIG. 1, depicting doors of the portable oven in a closed position, according to another embodiment of the present invention;

FIG. 7 is a cross-sectional view of the portable oven taken along section 7-7 line of FIG. 2, depicting the doors of the portable oven in an open position, according to another embodiment of the present invention;

FIG. 8 is a schematic view of the portable oven, according to another embodiment of the present invention;

FIG. 9 is a perspective view of a cooking station with multiple independent cooking modes, depicting an oven portion and a griddle device with their respective access structures in closed positions, according to another embodiment of the present invention;

FIG. 10 is a perspective view of the cooking station, depicting the oven portion with an oven door in an open position and the griddle device with a hood in an open position, according to another embodiment of the present invention;

FIG. 11 is an exploded view of some of the components of the cooking station, according to another embodiment of the present invention;

FIG. 12 is a cross-sectional view of the oven portion taken along section line 12-12 of FIG. 11, according to an embodiment of the present invention;

FIG. 13 is an exploded view of the oven portion, according to another embodiment of the present invention;

FIG. 14 is a perspective view of the griddle device of the cooking station, depicting an inner portion or framework of the griddle device, according to another embodiment of the present invention;

FIG. 15 is a cross-sectional view taken along section line 15-15 of FIG. 10, according to another embodiment of the present invention; and

FIG. 16 is a side view of the cooking station, according to another embodiment of the present invention.

### DETAILED DESCRIPTION OF THE INVENTION

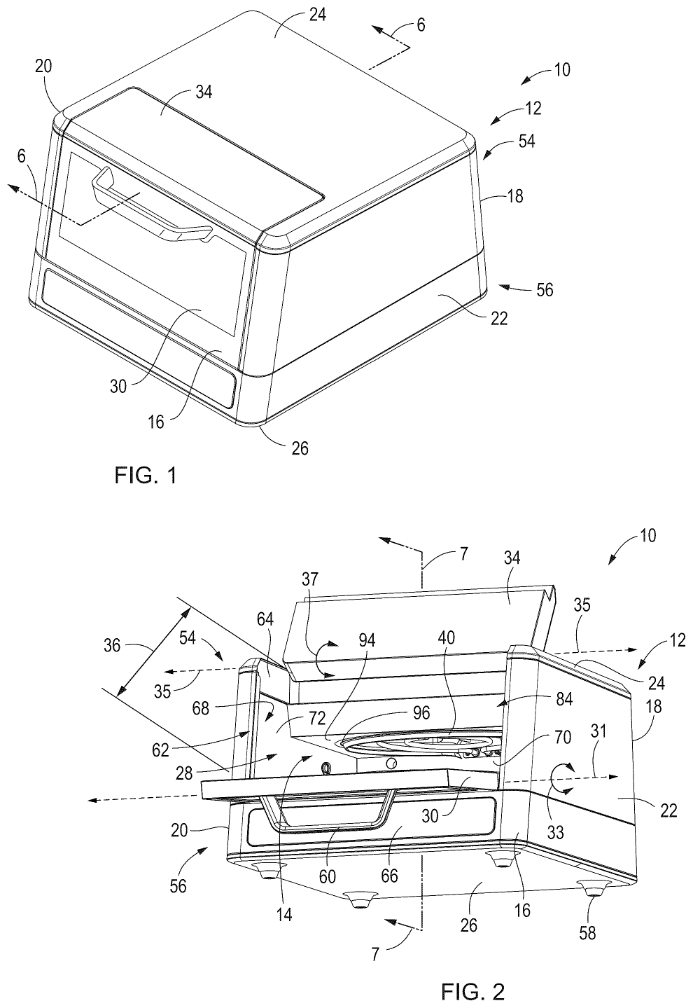

Referring to FIGS. 1 and 6, a portable oven 10 including a main body 12 and a cooking chamber 14 is provided. Such portable oven 10 may be employed for cooking outdoors and/or indoors such that the portable oven may be sized to readily move from one location to another. Further, the portable oven 10 may be employed for cooking with two different types of cooking or different cooking modes within a single cooking chamber 14. For example, the portable oven 10 may be used for cooking pizza or the like, being able to bake within the cooking chamber 14 at high temperatures, as well as having the functionality to air fry foods within the baking chamber 10.

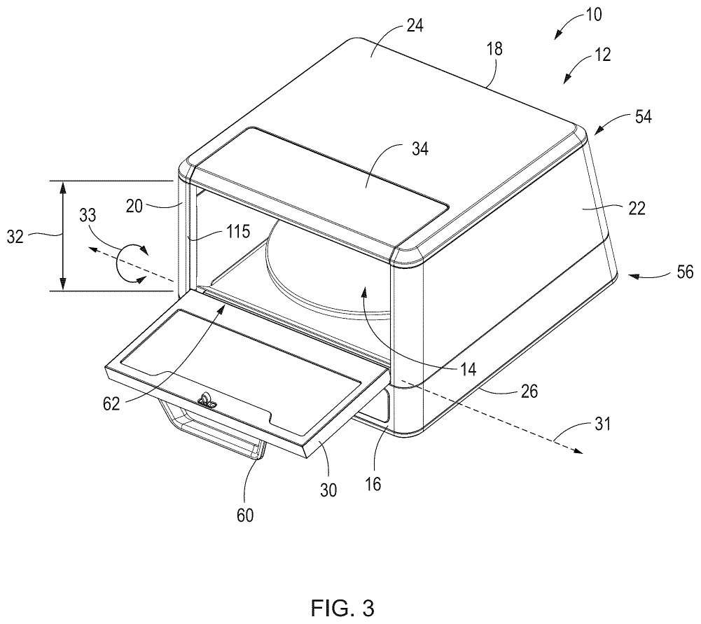

The main body 12 may include a front side 16, a rear side 18, a left side 20, a right side 22, an upper side 24, and a lower side 26 extending to define an interior 28 of the main body 12. The front side 16 of the main body 12 may include a front door 30 or main door configured to open into the cooking chamber 14 and to define a narrow chamber opening 32, as depicted in FIG. 3. The upper side 24 of the main body 12 may include an upper door 34 or secondary door that may extend transverse relative to the front door 30. The front door 30 may be positioned to be removably coupled to or lock in place to the upper door 34. The upper door 34 may be configured to open to the cooking chamber 14, such that the front door 30 and upper door 34 being open may define a wide chamber opening 36, as depicted in FIG. 2. The cooking chamber 14 may include one or more heating elements 38. The heating elements 38 may include an upper heating element 40 and a lower heating element 42. The upper heating element 40 may be positioned at an upper portion 44 of the cooking chamber 14 and the lower heating element 42 may be positioned at a lower portion 46 of the cooking chamber 14 such that a plate 48 may extend therebetween. The upper heating element 40 may have a fan 52 positioned above the upper heating element 40. Such fan 52 may be configured to facilitate air flow towards a cooking surface 50 of the plate 48.

Now with reference to FIGS. 1 and 2, as previously set forth, the portable oven 10 may include the main body 12 extending to define the front side 16, the rear side 18, the left side 20, the right side 22, the upper side 24, and the lower side 26. The front side 16 and the rear side 18 may be positioned opposite one another such that the front side 16 and the rear side 18 may extend parallel to the other. In another embodiment, the front and rear sides 16, 18 may extend tipped inward with top ends of the front and rear sides 16, 18 tipped toward each other. Further, the front side 16 and the rear side 18 may be coupled to the left side 20 and the right side 22 on opposing ends such that the left and right side 20, 22 may extend parallel to one another and may extend perpendicular or transverse to the front side 16 and the rear side 18. The front side 16, the rear side 18, the left side 20, and the right side 22 may extend continuously to define an upper periphery 54 and a lower periphery 56. The upper side 24 may be coupled to the front side 16, the rear side 18, the left side 20, and the right side 22 along the upper periphery 54. The lower side 26 may be coupled to the front side 16, the rear side 18, the left side 20, and the right side 22 along the lower periphery 56. The upper side 24 and lower side 26 may extend generally parallel to one another and perpendicular or transverse to the front side 16, the rear side 18, the left side 20, and the right side 22. The lower side 26 of the main body 12 may include feet 58 extending therefrom, the feet 58 sized and configured to suspend the main body 12 over a counter-top or other floor type surface. In this configuration, the front side 16, the rear side 18, the left side 20, the right side 22, the upper side 24, and the lower side 26 may extend to define the interior 28 of the main body 12. The interior 28 of the main body 12 may include the cooking chamber 14 defined therein. With this arrangement, the main body 12 may have various panels that extend to define an enclosable structure.

With reference to FIGS. 2, and 3, the front side 16 may include the front door 30 positioned thereon. The front door 30 may extend from or adjacently along the lower periphery 56 towards the upper periphery 54 of the front side 16. The front door 30 may be hingeably coupled to the front side 16 near the lower periphery 56 such that the front door 30 may open away from the main body 12. Further, the front door 30 may be configured to be moveable between an open position and a closed position such that the front door 30 is pivotable about a first pivot axis 31, as shown by arrow 33. The open position may provide access to the cooking chamber 14 by means of the front door 30 opening towards the lower side 26 of the main body 12. In a further embodiment, the front door 30 may open towards the left or right sides 20, 22 to provide access to the cooking chamber 14. With the front door 30 opening towards the lower side 26 of the main body 12, the front door 30 may extend substantially parallel to the lower side 26 of the main body 12 when in the open position or may extend to face downward in the open position. Further, the front door 30 may include a handle 60 positioned thereon configured to be employed for moving the front door 30 between the open and closed positions.

The upper side 24 may include the upper door 34 extending over a portion of the upper side 24 of the main body 12 so as to extend transverse to the front side 16 of the main body 12. The upper door 34 may extend from the front door 30 towards the rear side 18 of the main body 12. Further, the upper door 34 may be hingeably coupled to the upper side 24 of the main body 12 such that the upper door 34 may open and close a portion of the upper side 24 of the main body 12. The upper door 34, being in the open position, may open towards the rear side 18 and may provide further access into the cooking chamber 14.

The front door 30 and the upper door 34 may define a chamber opening 62 configured to provide access to the cooking chamber 14. The front door 30, being in the open position, and the upper door 34, being in the closed position, may define the narrow chamber opening 32, as depicted in FIG. 3. The narrow chamber opening 32 may be defined partially by the left side 20, the right side 22, and the upper door 34. Further, the narrow chamber opening 32 may become the wide chamber opening 36 with the upper door 34 being in the open position such that the wide chamber opening 36 is defined by the front side 16, the left side 20, the right side 22, and the upper side 24 of the main body 12. As such, the wide chamber opening 36 is larger than the narrow chamber opening 34. In this manner, the wide chamber opening 36 may provide widened or a larger access space into the cooking chamber 14 than the narrow chamber opening 32. In this manner, the wide chamber opening 36 is configured to facilitate ready access into the cooking chamber 14 upon, for example, a user placing or retrieving the food therein.

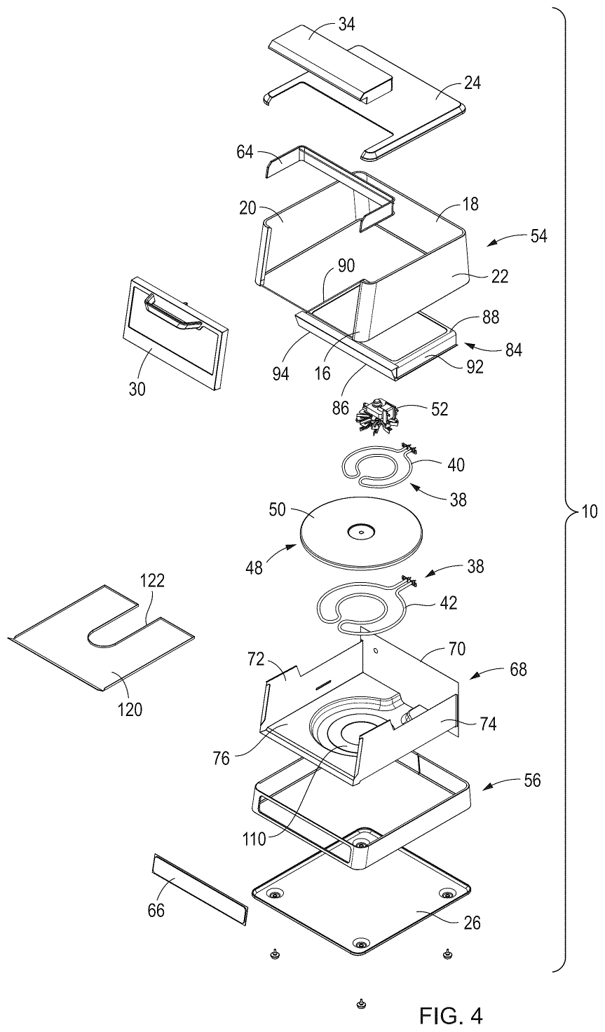

With reference to FIGS. 2 and 4, an upper door frame 64 of the portable oven 10 may be included in the interior 28 of the main body 12. The upper door frame 64 may be configured to support the upper door 34. The upper door frame 64 may be coupled to the upper side 24, the left side 20, and the right side 22 of the main body 12 such that the upper door frame 64 may extend into the interior 28 of the main body 12 at a width similar to the upper door 34. Further, the upper door frame 64 may be configured to extend with the upper door 34 upon the upper door 34 being in the closed position. In one embodiment, the upper door 34 may be hingeably coupled to the upper door frame 64 such that the upper door 34 may rotate about a second pivot axis 35, as shown by arrow 37, to facilitate the upper door to move between closed and open positions. In the closed position, the upper door 34 may extending parallel to the lower side 26 of the main body 12 and may extend flush with the upper side 24. In the open position, the upper door 34 may be positioned to extend transverse relative to the upper side 24.

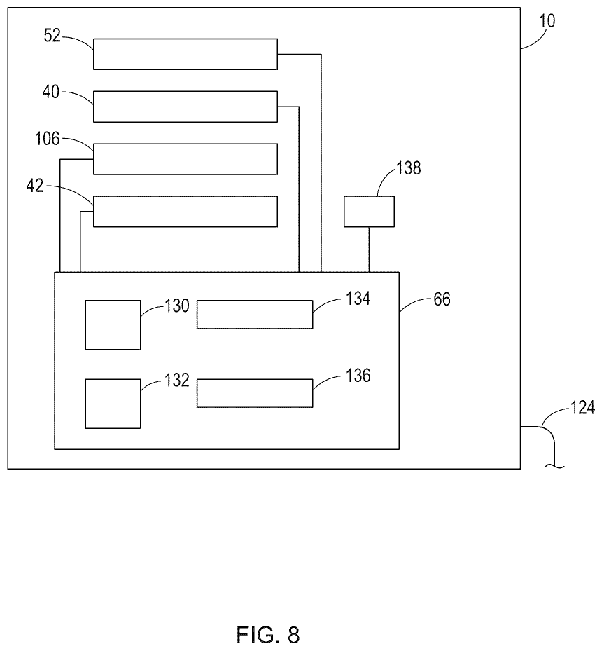

As previously set forth, the front side 16, the rear side 18, the left side 20, and the right side 22 may extend to define the upper periphery 54 and the lower periphery 56. Each side may be formed from panels and various frame components to form the main body 12. Further, the front side 16 may include a control panel 66, positioned below the front door 30 and adjacently along the lower periphery of the main body 12. The control panel 66 may include a controller and may be configured to control one or more functional components of the portable oven 10. In another embodiment, the control panel 66 may include an input and an output. The input may be in the form of buttons and/or knobs, or a touch sensitive screen that may control various functions, such as temperature or a fan 52 of the oven 10. The output may be in the form of a digital display to show, for example, actual and desired temperatures of the oven 10 and, as such, the oven may also include various temperature sensors 138 (FIG. 8). Such electronics of the control panel 66 may be implemented with the oven 10, as known to one of ordinary skill in the art.

In one embodiment, the control panel 66 may be a touch sensitive display that may be employed and configured to control the upper heating element 40 and the lower heating element 42 as well as the fan 52 positioned within the cooking chamber 14 of the main body 12. For example, the touch sensitive display may include pre-set controls for controlling, for example, the mixing of air with the fan 52 and the heating the upper heating element 40 and/or the lower heating element 42. The pre-set controls may be displayed to a user as, for example, (1) fresh pizza, (2) frozen pizza, (3) bake, and/or (4) air fry, each of which may be single touch controls on the touch sensitive display of the control panel 66 or some other way of implementing the pre-set controls, as known to one of ordinary skill in the art. The lower periphery 56 along the front side 16 of the main body 12 may extend up to a height similar to the level of the control panel 66 or just below the control panel 66. The upper periphery 54 along the front side 16 of the main body 12 may extend along a level of the end of the upper door 34, upon the upper door 34 being in the closed position (see FIG. 1).

The interior 28 of the main body 12 may include a heat shield 68 positioned therein. The heat shield 68 may extend to define a rear wall 70, a left wall 72, and a right wall 74 extending continuously relative to each other and extending generally parallel to the respective rear side 18, the left side 20, and the right side 22 of the main body 12. The heat shield 68 may at least partially define the cooking chamber 14. Further, the heat shield 68 may be configured to provide a barrier to the rear side 18, the left side 20, and the right side 22 from heat generated by the heating elements 38. The heat shield 68 may be formed with a reflective surface that may be configured to reflect and radiate heat generally toward a center of the cooking chamber 14. The heat shield 68 may also include a lower wall 76 coupled to the rear wall 70, the left wall 72, and the right wall 74, such that the lower wall 76 may extend generally perpendicular or transverse relative to the rear wall 70, the left wall 72, and the right wall 74. The lower wall 76 may also at least partially define the cooking chamber 14 such that the lower wall 76 may define the lower portion 46 (FIG. 6) of the cooking chamber 14.

Now with reference to FIGS. 4 and 6, the cooking chamber 14 may be defined to include the upper portion 44 and the lower portion 46. The lower wall 76 of the heat shield 68 may define the lower portion 46 of the cooking chamber 14. Further, the cooking chamber 14 may include heating elements 38 positioned therein. The heating elements 38 may include the upper heating element 40 and the lower heating element 42 positioned on opposite sides of the cooking chamber 14 such that the cooking surface 50 may be positioned therebetween. The upper heating element 40 may be positioned along the upper portion 44 of the cooking chamber 14 so as to extend below the upper side 24 of the interior 28 of the main body 12. The lower heating element 42 may be positioned on the lower portion 46 of the cooking chamber 14 so as to extend over the lower wall 76 of the heat shield 68. In one embodiment, the upper heating element 40 and lower heating element 42 may both be configured to be electrically generated heating elements. The upper heating element 40 may radiate heat therefrom so as to radiate downward toward the plate 48, or the cooking surface 50. The lower heating element 42 may radiate heat therefrom so as to directly heat an underside of the plate 48. In another embodiment, the upper heating element 40 may be electrical while the lower heating element 42 may be configured as a gas-powered heat element to directly heat the plate 48. The upper heating element 40 and the lower heating element 42 may extend with circular configurations or with radial configurations. For example, the upper heating element 40 and the lower heating element 42 may both extend in a coil like configuration. In another embodiment, the upper and lower heating elements 40, 42 may extend with a different configuration relative to each other, such that one may extend with a circular configuration and another one may extend with a u-configuration. In another embodiment, the upper and lower heating elements 40, 42 may extend radially such that one side may extend with additional radial configurations so that the one side may provide more heat than other sides of the upper and lower heating elements 40, 42. Further, in another embodiment, the upper and lower heating elements may be offset relative to the plate 48.

The fan 52 may be positioned along the upper portion 44 of the cooking chamber 14 such that the fan 52 may be coupled to the upper side 24 of the interior 28 of the main body 12. The fan 52 may include a fan motor 78, a drive shaft 80, and fan blades 82. The fan motor 78 may be coupled to the drive shaft 80 and configured to turn the drive shaft 80, to thereby turn the fan blades 82. The fan 52 may be positioned along the upper portion 44 of the cooking chamber 14 so as to generate air flow through the upper heating element 40. As such, the fan 52 may be positioned adjacently behind the upper heating element 40 and configured to push air toward the cooking surface 50 positioned within the cooking chamber 14. In another embodiment, the fan 52 may be positioned in the upper portion 44 of the cooking chamber 14 in a version of the oven 10 where the upper heating element 40 may not be included in the main body 12 such that the fan 52 may be configured to mix or stir warmed air, produced by the lower heating element 42 alone, being electrical or gas fueled, throughout the cooking chamber 14. In this manner, the fan 52 along with the heating elements 38 may facilitate air frying food positioned over the plate 48, the fan generating the mixing and stirring of air within the cooking chamber 14 of the portable oven 10.

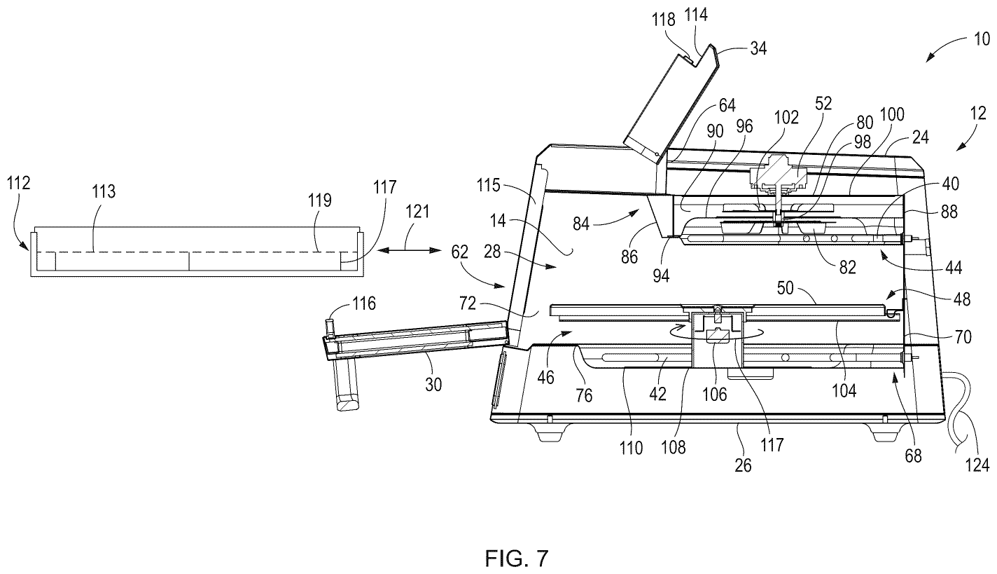

With respect to FIGS. 6 and 7, in another embodiment, the portable oven 10 may include a tray 112 or some other type of container, such as a wire basket that may be positioned on the plate 48 for positioning various types of food therein for the purpose of air frying the food within the tray 112. Further, the main body 12 may include a power cord 124 extending, for example, from the rear side 18 of the main body. The power cord 124 may be of the type to fit within a typical power outlet within a residential home and may facilitate powering each of the upper and lower heating elements 40, 42 and the fan 52 and any other electrical component associated with the portable oven 10, such as a control panel 66 (FIG. 2), as known to one of ordinary skill in the art. In one embodiment, the rear side 18 of the main body 12 may include projections (not shown), such as L-shaped projections, that may extend from, or sit flush with, the rear side of the main body 12. Such projections may be sized and configured to facilitate wrapping the power cord 124 therearound, upon the power cord 124 not being in use.

With reference to FIGS. 4, 6, and 7, the interior 28 may also include an upper housing 84 positioned and coupled to the upper side 24 of the interior 28 of the main body 12. In another embodiment, the upper housing 84 may be coupled to the upper door frame 64 and the rear wall 70, the left wall 72, and the right wall 74 of the heat shield 68. The upper housing 84 may extend to define a front panel 86, a rear panel 88, a left panel 90, a right panel 92, and a bottom panel 94. The front panel 86 may be coupled to the upper door frame 64 and the rear panel 88 may be coupled to the rear wall 70 of the heat shield 68. The left panel 90 and the right panel 92 may be coupled to the left and right walls 72, 74 of the heat shield 68, respectively. The upper housing 84 may be configured to encase and provide a barrier to the fan motor 78 of the fan 52 so that portions of the fan 52 may not be exposed to the heat of the cooking chamber 14. Further, the upper housing 84 may extend from the upper side 24 of the interior 28 of the main body 12 such that the bottom panel 94 of the upper housing 84 may extend to define the upper portion 44 of the cooking chamber 14.

Now with reference to FIGS. 2, 4, and 6, the bottom 94 of the upper housing 84 may extend to define an upper mold 96 extending into the upper housing 84. The upper mold 96 may be sized and configured for the upper heating element 40 to be positioned therein. The upper mold 96 may extend in a circular shape, or in a shape made to facilitate housing the upper heating element 40. The upper mold 96, having the upper heating element 40 positioned therein, may also include an upper opening 98 sized and configured for the drive shaft 80 of the fan 52 to extend therethrough such that the drive shaft 80 may extend to the fan blades 82. The fan blades 82 may be positioned outside of the upper housing 84 and above the upper heating element 40. In this configuration, the fan blades 82 and upper heating element 40 may be positioned within the upper portion 44 of the cooking chamber 14 and within the upper mold 96.

The upper housing 84 may also extend to include a top 100 coupled to and extending to the front panel 86, the rear panel 88, the left panel 90, and the right panel 92 of the upper housing 84. The upper housing 84, being coupled to the main body 12 and having a top 100, may define a space 101 extending between the top 100 of the upper housing 84 and the upper side 24 of the main body. The top may include an opening 102 defined therein configured to allow the drive shaft 80 of the fan 52 to extend therethrough such that a portion of the drive shaft 80 may extend within the upper housing 84. The fan motor 78 of the fan 52 may not be encased by the upper housing 84, rather, the fan motor 78 may extend within the space 101 between the top 100 of the upper housing 84 and the upper side 24 of the main body 12. In this configuration, the upper housing 84 may be a barrier between the cooking chamber 14 and the fan motor 78 to minimize potential heat damage to the fan motor 78.

Now with reference to FIGS. 6 and 7, the plate 48 may be positioned within the cooking chamber 14 between the upper heating element 40 and the lower heating element 42. The plate 48 may define the cooking surface 50 and an underside surface 104, where the cooking surface 50 may be configured to cook food thereon. The plate 48 may be coupled to a motor 106 positioned adjacent the lower portion 46 of the cooking chamber 14. In other embodiments, the motor 106 may be positioned adjacent the lower side 26 of the interior 28 of the main body 12, such that a drive shaft 108 may be in contact or coupled to the underside surface 104 of the plate 48 so that the drive shaft 108 may rotate the plate 48, as shown by rotational arrow 117. In one embodiment, the motor 106 and the plate 48 may be removably coupled to the underside surface 104 of the main body 12. Further, the motor 106 may be surrounded by the drive shaft 108 that may act as a housing or heat shield to protect the motor 106 from the lower heating element 42. In this embodiment, the drive shaft 108 may be cylindrical or in the form of a sleeve so that the motor may be positioned within the drive shaft 108. With this arrangement, the plate 48 may be rotated to assist in even heating of the plate 48 and food cooked thereon by the upper and lower heating elements 40, 42. Further, the rotating flat cooking surface 50 of the portable oven 10 described herein has similar features and functionality to that described in commonly assigned U.S. patent application Ser. No. 18/110,730, filed on Feb. 16, 2023, and entitled “OUTDOOR OVEN WITH MODIFIABLE PORTABILITY, SYSTEM AND METHOD THEREOF,” the contents of which is incorporated by reference herein in its entirety.

Similar to the upper mold 96 of the bottom 94 of the upper housing 84, the lower mold 110 may be positioned on the lower wall 76 of the heat shield 68. The lower mold 110 may extend from the lower wall 76 of the heat shield 68 towards the lower side 26 of the main body 12. The lower mold 110 may be sized and configured for the lower heating element 42 to be positioned therein such that the lower heating element 42 being positioned within the lower mold 110 of the heat shield 68 may extend flush with the lower wall 76 of the heat shield 68. The upper and lower molds 96, 110 may not be actual molds, but may be formed structures configured to at least partially house the corresponding heating elements 38. Further, the upper and lower molds 96, 110 may be made of a reflective material that further facilitates radiating heat toward a center region of the cooking chamber 14.

The cooking surface 50 of the plate 48 may extend as a solid flat upper surface. In one embodiment, the cooking surface 50 of the plate 48 may be formed from a cast iron material, or any other suitable metal material, such as stainless steel. In another embodiment, the cooking surface 50 of the plate 48 may be formed from a stone like material, such as a pizza stone material. In another embodiment, as previously set forth, the oven 10 may include a tray 112 that may be positioned directly onto the cooking surface 50 of the plate 48. Such a tray 112 may include a peripheral upstanding wall so that the tray may be employed as a container for holding food therein for air-frying in the oven 10. The tray 112 may be a sold circular sheet with the upstanding side wall. Further, such tray 112 may be sized and configured to hold a low-profile perforated trivet 113 therein (similar to a wire basket) so that the trivet 113 can allow food byproduct to drip onto the tray 112 and allow hot air to flow under and around the food positioned within the tray 112 and over the trivet 113. The trivet 113 may be removable from the tray 112 such that it simply may sit within the tray 112 with trivet legs 117 suspending the trivet 113 within the tray 112. Such trivet 113 may extend with holes or perforations 119 to facilitate free air flow around food placed on the trivet 113. In this manner, the tray 112 and trivet 113 may be readily removed from, and positioned in, the cooking chamber 14, as shown by arrow 121. As such, the oven 10 may be employed with a dual cooking function of, for example, cooking food directly on the cooking surface 50 of the plate 48, such as pizza or the like, or by cooking other types of food in the tray 112 and on the trivet 113 with the heating elements 38 and fan 52 mixing air within the chamber 14 of the oven 10, thereby, employing the air-frying function of the oven 10.

With reference to FIGS. 3, 6 and 7, the front side 16 of the main body 12 may extend upward at a slight angle such that the front door 30 may extend to rest or sit along a front door frame lip 115 exhibited along a front side 16 of the main body 12, upon the front door 30 being in the closed position. The upper door 34 may also be positioned along an upper edge of the upper door frame 64 along the upper side 24 of the main body 12, upon the upper door 34 being in the closed position. In one embodiment, the upper door 34 may extend to define a lip 114 sized and configured to extend over one end of the front door 30, upon the front door 30 and the upper door 34 being in the closed position. In another embodiment, the front door 30 may be removably coupled to the upper door 34 with a coupling mechanism. Such coupling mechanism may be a latch 116 positioned on the front door 30 and a receiver 118 positioned on the upper door 34. The latch 116 of the front door 30 may be positioned to correspond and cooperate with the receiver 118 of the upper door 34. The coupling mechanism between the front and upper doors 30, 34 may be a hook type latch mechanism that may be releasable on, for example, the handle 60. In another embodiment, the coupling mechanism may be a magnetic coupling type mechanism. In another embodiment, the coupling mechanism may be a combination hook type and magnetic coupling mechanism. With this arrangement, the latch 116 of the front door 30 and the receiver 118 of the upper door 34 may be configured to require force for the latch 116 to be removed from the receiver 118. Further, the upper door 34 may not be opened unless the front door 30 is unlatched from the upper door 34.

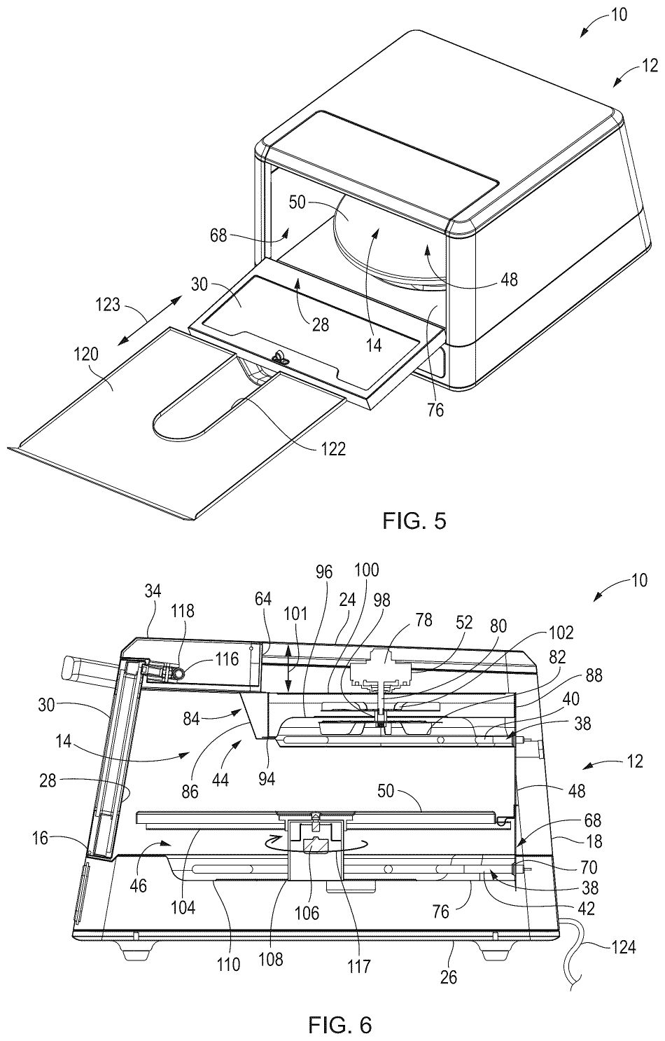

With reference to FIGS. 4 and 5, the interior 28 of the main body 12 may also include a removable crumb tray 120. The crumb tray 120 may be configured to capture crumbs or other types of food byproduct that may fall from the cooking surface 50 of the plate 48. The crumb tray 120 may be positioned below the plate 48 such that the crumb tray 120 may rest on the lower wall 76 of the heat shield 68. The crumb tray 120 may extend at least partially over the lower heating element 42. Further, the crumb tray 120 may be configured to keep food debris from falling into the lower mold 110 of the lower wall 76 of the heat shield 68. In one embodiment, the crumb tray 120 may extend with a u shaped (or any other suitable shape) with a channel 122 positioned such that the channel 122 may be configured for the housing for the motor 106 (FIG. 6) coupled to the plate 48 to extend therethrough. In another embodiment, the crumb tray 120 may be circular with a hole for positioning the drive shaft 108 of the motor 106. In another embodiment, the crumb tray 120 may rest on the lower wall 76 of the heat shield 68 and may be configured to be heated by the lower heating element 42 and radiate heat towards the plate 48. In a further embodiment, the crumb tray 120 may extend on the lower wall 76 with the channel 122 extending to allow for the lower heating element 42 to be exposed such that the lower heating element 42 may directly heat the cooking chamber 14. In another embodiment, the crumb tray 120 may be formed from steel or aluminum sheet material, or any other metallic sheet structure. Such crumb tray 120 may be readily removable from, and positionable within, the oven 10 upon opening the front door 30, as depicted by arrow 123, such that the front door 30 may be sized to facilitate ready access to the crumb tray 120 below the plate 48.

With reference to FIGS. 6 and 8, as previously set forth, the portable oven 10 may include a control panel 66, which may also be referenced as a controller. The portable oven 10 may be powered with a typical residential outlet, for example, an outlet that may supply 120 or 240 volts, such that the oven 10 may be supplied with such power with a power cord 124. The control panel 66 may include or be associated with input and output devices 130, 132. The input device 130 may include analog type knobs, switches and/or buttons integrated with the oven 10. Further, the input device 130 may be a touch sensitive digital display, or a combination of digital and analog type input controls. Such touch sensitive digital display may also be the output device 132. The output device may also be a secondary display or a non-touch sensitive display. In another embodiment, the control panel 66 may also include one or more processors 134 and one or more memory 136, which may include programming and software designed and configured to implement the functions of the portable oven 10, as known by one of ordinary skill in the art, such as the previously discussed pre-set controls. Further, in another embodiment, the oven 10 may include one or more sensors 138, such as temperature sensors, that may be coupled to the control panel 66 and positioned in or on the oven 10 at locations to assist the user to know the actual temperatures of the external surface of the portable oven and/or the cooking chamber 14 of the portable oven 10. The control panel 66 of the portable oven 10 may be coupled to each of the fan motor 78 of the fan 52, the upper and lower heat elements 40, 42 and the motor 106 to rotate the plate 48 of the portable oven. As previously set forth, the control panel 66 of the portable oven 10, with its processors and memory 134, 136, may include the pre-set controls for a user to select to utilize the various cooking functionalities of the portable oven 10 employing the upper and lower heating elements 40, 42, and/or the fan 52. In this manner, the portable oven 10 may be employed by a user for indoor and outdoor use and to cook various types of food with multiple cooking modes within the same cooking chamber 14, such as employing the cooking chamber 14 as an oven as well as employing the cooking chamber 14 for air frying therein. As previously set forth, the pre-set controls may be displayed to a user as, for example, (1) fresh pizza, (2) frozen pizza, (3) bake, and/or (4) air fry, each of which may be implemented at the control panel 66 or with a control knob. As such, the portable oven 10 may be employed in various cooking modes relative to, for example, the pre-set controls within a single cooking chamber. For example, upon the portable oven 10 being used in an air frying mode (which may be implemented in the pre-set controls with the control panel 66), the upper heating element 40 and the fan 52 may be automatically electrically activated for cooking food within the cooking chamber. In the air frying mode, the lower heating element may not be activated or may be activated at a low level. Further, upon the portable oven 10 being used in an oven mode or a pizza oven mode (which may apply with slight variations to each of the pre-set controls of fresh pizza, frozen pizza, and bake), the upper and lower heating elements 40, 42 may be activated via the control panel 66 and its programming therein. In some examples, the pre-set controls of the oven mode for cooking “fresh pizza” may include pre-heating the cooking chamber 14 by only heating the lower heating element 42 to heat the plate 48 and, upon completing the step of pre-heating the cooking chamber 14, then activating the upper heating element 40 while maintaining the temperature of the plate 48 or turning the lower heating element off. There may be variations in how the upper and lower heating elements 40, 42 are activated between the variations of oven mode for cooking “fresh pizza, frozen pizza, and bake,” as set forth in the pre-set controls and the programming therewith. In this manner, the portable oven 10 may be employed to cook different types of food with differently types of cooking modes.

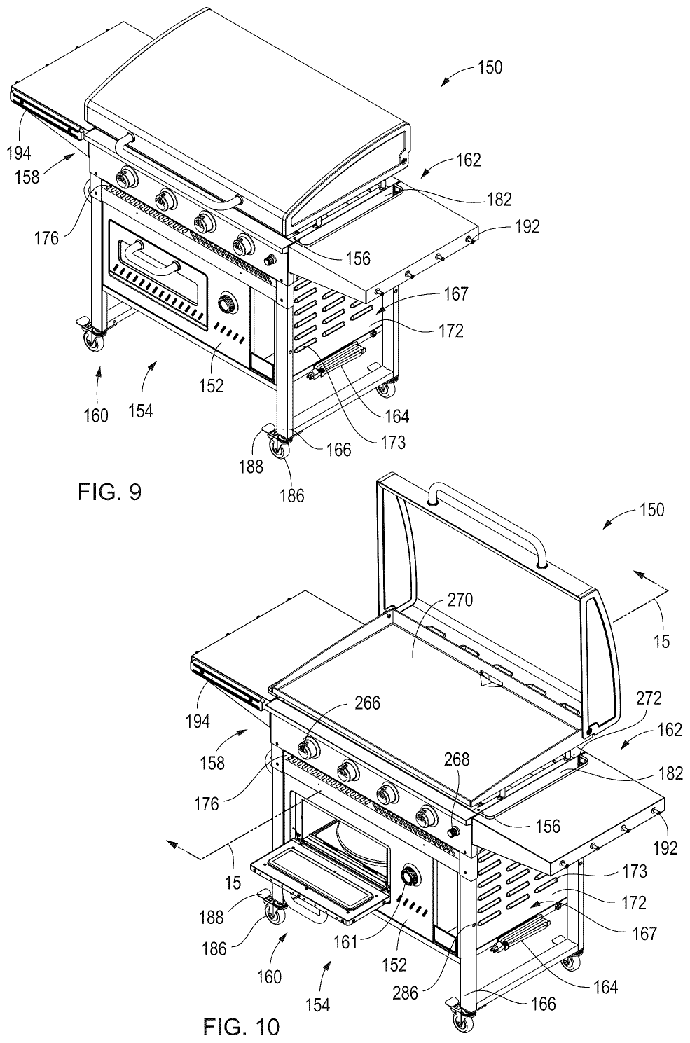

Now with reference to FIGS. 9 and 10, in another embodiment, many of the components of the portable oven described in FIGS. 1-8 may be employed in combination with another cooking device, such as a griddle type cooking station. As such, in this embodiment, a cooking station 150 with multiple independent cooking modes is provided. The cooking station 150 may include an oven portion 152 and a griddle device 156. The oven portion 152 may be referenced as a first cooking portion 154 of the cooking station 150. The griddle device 156 may be referenced as a second cooking portion 158 of the cooking station 150. Further, the cooking station 150 may extend to define a first portion 160 and a second portion 162. The first portion 160 of the cooking station 150 may include the first cooking portion 154 or the oven portion 152. The second portion 162 of the cooking station 150 may include the second cooking portion 158 or the griddle device 156. Both the oven portion 152 and griddle device 156 may function independently of one another such that each cooking portion may be employed to cook food simultaneously and may each be dedicated to cook food independent of each other. Further, the oven portion 152 and the griddle device 156 may be configured to cook food with separate and independent fuel sources. In one embodiment, the oven portion 152 may be configured to generate heat with electric components and may include an electrical cord 164 coupled thereto. The griddle device 156 may be configured for generate heat by combusting gas, where the gas may be propane or natural gas. In this manner, the oven portion 152 and griddle device 156 may be fueled and employed independent of one another with separate and different energy sources.

With reference to FIGS. 9-11, as previously set forth, the cooking station 150 may extend to define the first portion 160 and the second portion 162, the first and second portions 160, 162 defining the oven portion 152 and the griddle device 156, respectively. The cooking station 150 may include multiple legs 166 coupled to the second portion 162 (or the first portion 160) and extending downward so as to support the cooking station 150 on the ground or floor surface. The first portion 160 may be positioned to extend between the multiple legs 166 and below the second portion 162. Further, the framework of the first portion 160 may include an external wall structure 167 extending to define a rear barrier 168, a left barrier 170, and a right barrier 172. The left and right barriers 170, 172 may extend opposite and parallel to one another. The rear barrier 168 may be perpendicular to the left and right barriers 170, 172 and may extend therebetween. The rear, left, and right barriers 168, 170, 172 of the first portion 160 may be coupled to the multiple legs 166 extending therebetween. As such, the first portion 160 may be defined between the multiple legs 166 of the cooking station 150 and below the second portion 162. Further, the rear, left, and right barriers 168, 170, 172 may extend with a height 174 which may extend along at least a portion of the length of the multiple legs 166. Further, the height 174 may extend most of the length of the multiple legs 166. In this manner, the rear, left, and right barriers 168, 170, 172 may extend to at least partially encase the oven portion 152 therein. Further, one, some or each of the rear, left and right barriers 168, 170, 172 may include venting 173 defined therein so as to facilitate air flow through the venting of any one of the rear, left and right barriers 168, 170 and 172.

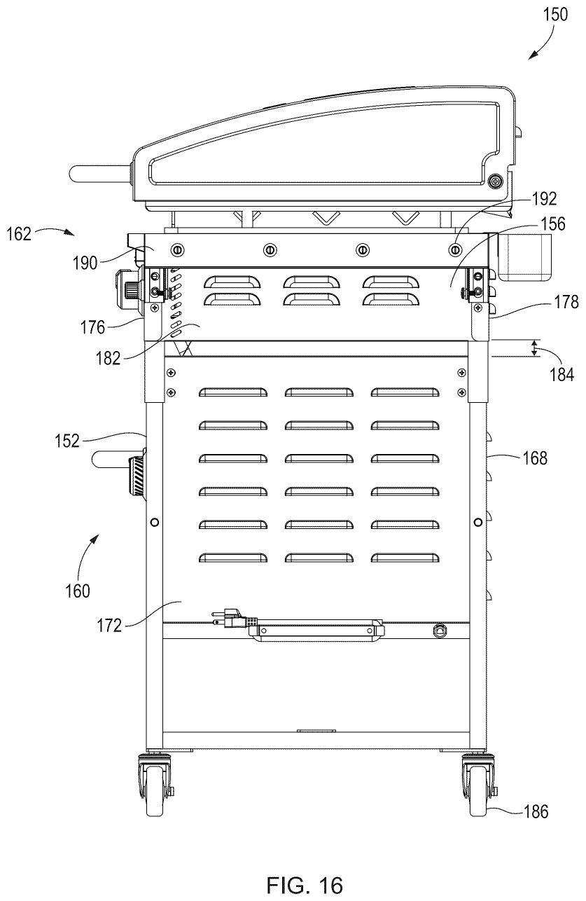

Now with reference to FIGS. 9-11 and 16, the framework of the second portion 162 of the cooking station 150 may extend to define a front panel 176, a rear panel 178, a left panel 180, and a right panel 182. The front and rear panels 176, 178 may extend opposite and parallel to one another. The left and right panels 180, 182 may be coupled to opposite ends of the front and rear panels 176, 178 and may extend parallel to each other. In this configuration, the front, rear, left, and right panels 176, 178, 180, 182 may extend with a rectangular profile. As previously set forth, the first portion 160 may be below the second portion 162. In one embodiment, the rear, left, and right barriers 168, 170, 172 may extend to be coupled to the rear, left, and right panels 178, 180, 182 of the second portion 162. In another embodiment, a gap 184 may be defined between the rear, left, and right barriers 168, 170, 172 and the rear, left, and right panels 178, 180, 182. The gap 184 may be configured to facilitate air flow between the first and second portions 160, 162 of the cooking station 150. In one embodiment, the gap 184 may facilitate ventilating heat from the oven portion 152 and the griddle device 156 of the cooking station 150.

The multiple legs 166 may include caster wheels 186 with brakes 188 configured to allow for the cooking station 150 to be readily moveable along a flat surface as well as lock in place. The cooking station 150 may also include multiple accessories such as side shelves 190, multiple hooks 192, and a magnetic bar 194. The side shelves 190 may be coupled to the left and right panels 180, 182 of the second portion 162. Further, the side shelves 190 may be configured to provide a flat surface for food preparation and placement of items while, for example, cooking with the cooking station 150. The multiple hooks 192 and the magnetic bar 194 may be coupled to the side shelves 190 and be configured to store cooking utensils thereon. The multiple hooks 192 may allow for cooking utensils to be hung thereon. The magnetic bar 194 may magnetize metal cooking utensils or spice jars thereto.

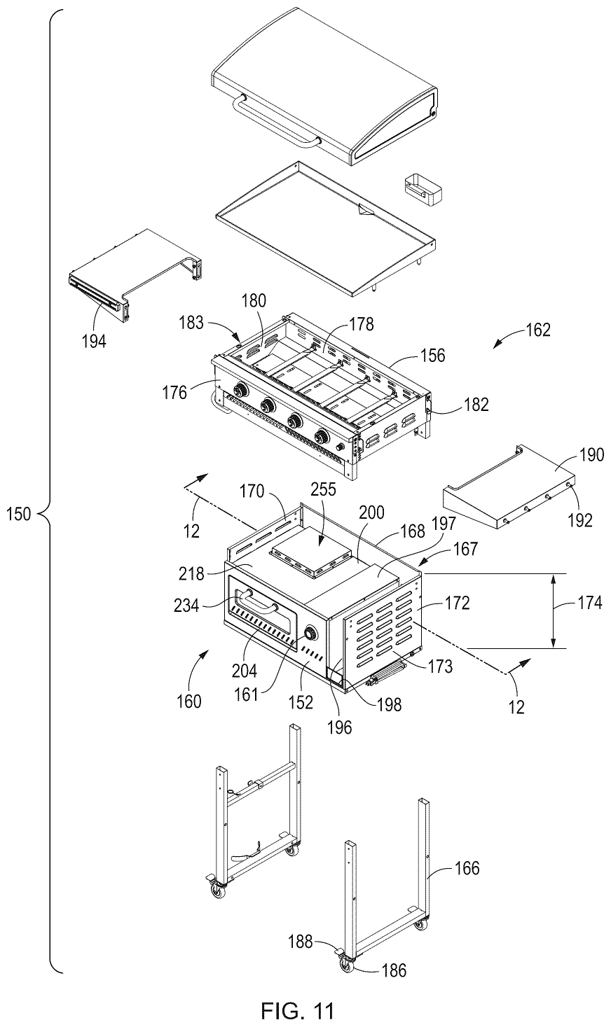

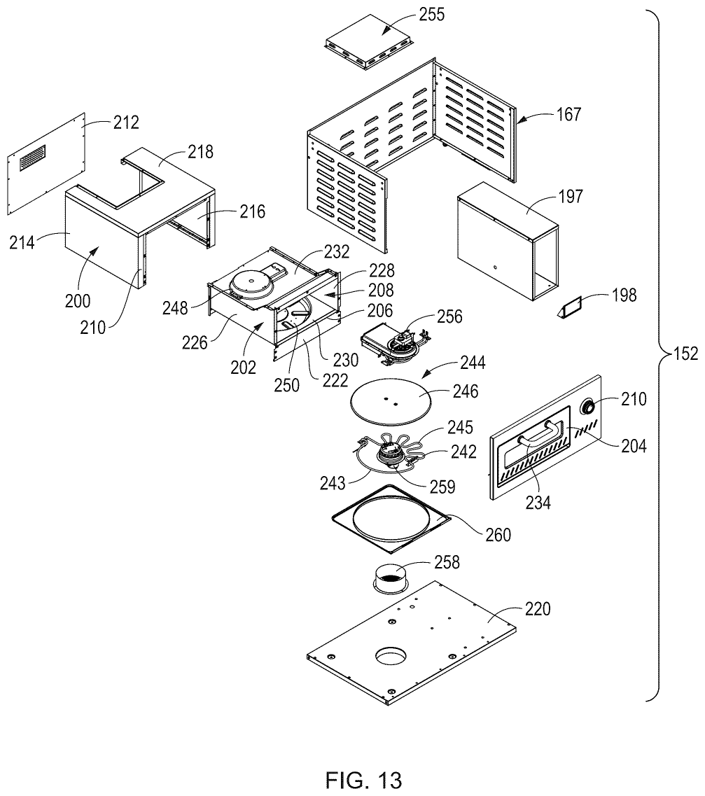

With reference to FIGS. 11-13, the first portion or the oven portion 152 may include multiple components. For example, the oven portion 152 may include a cooking chamber structure 202 or first heat shield, a secondary heat shield 200, and the external wall structure 167. The rear, left, and right barriers 168, 170, 172 of the external wall structure 167 of the oven portion 152 may at least partially surround the cooking chamber structure 202. Such cooking chamber structure 202 may act as a heat shield. The cooking chamber structure 202 may be sized to be positioned between walls of the secondary heat shield 200. In one embodiment, adjacent to the secondary heat shield 200 and along one side thereof, a container 197 may be positioned. Such container 197 may be positioned to hold and protect some of the electronics of the oven portion 152. Further, the container 197 may be positioned to provide a space between the container 197 and the right barrier 172 of the external wall structure 167 so as to define a storage structure 196. In another embodiment, the storage structure 196 may be positioned adjacent to the left barrier 170. The storage structure 196 may extend to define a slot sized and configured to hold pans, trays, a wire basket, a pizza peel or other cooking utensils or dishes or the like. The storage structure 196 defined partially by the container 197 may include a blocking piece 198. The blocking piece 198 may extend partially along a bottom front side of the storage structure 196. The blocking piece 198 may be positioned within the slot of the storage structure 196 to assist items placed within the storage structure to be maintained from being unintentionally removed from the storage structure 196.

As previously set forth, the oven portion 152 may be configured to include similar components and function to the portable oven 10 of FIGS. 1-8, described in the previous embodiments above. As such, the oven portion 152 may include, among other things, the cooking chamber structure 202, a front door 204 (or access member), a chamber opening 206, and a cooking chamber 208. The front door 204 may be pivotably coupled below the chamber opening 206 along a portion of the cooking chamber structure 202 so that the front door 204 may pivot between a closed position (FIG. 9) and an open position (FIG. 10). In other embodiments, the front door 204 may be positioned to pivot above the chamber opening 206 or may be positioned to pivot along one side of the chamber opening 206. Such front door 204 may be readily moveable between the closed and open positions with a chamber door handle 234. As such, the chamber door handle 234 may be fixed to the front door 204 to facilitate accessing the cooking chamber 208 of the oven portion 152 of the cooking station 150.

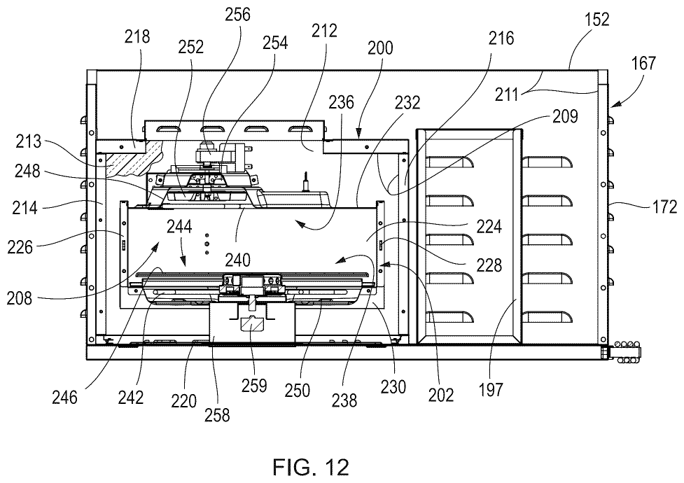

Further, the secondary heat shield 200 may extend to define a front side 210, a rear side 212, a left side 214, a right side 216, an upper side 218, and a lower side 220. The front, rear, left, right, upper, and lower sides 210, 212, 214, 216, 218, 220 may extend to encase or surround the cooking chamber structure 202. The cooking chamber structure 202 may extend to define a front wall 222, a rear wall 224, a left wall 226, a right wall 228, a lower wall 230, and an upper wall 232. The front, rear, left, right, lower, and upper walls 222, 224, 226, 228, 230, 232 of the cooking chamber structure 202 may extend somewhat or generally extend parallel relative to the respective front, rear, left, right, upper, and lower sides 210, 212, 214, 216, 218, 220 of the secondary heat shield 200. With this arrangement, the secondary heat shield 200 extends around the cooking chamber structure 202 with a first spaced gap 209 therebetween (see FIG. 12).

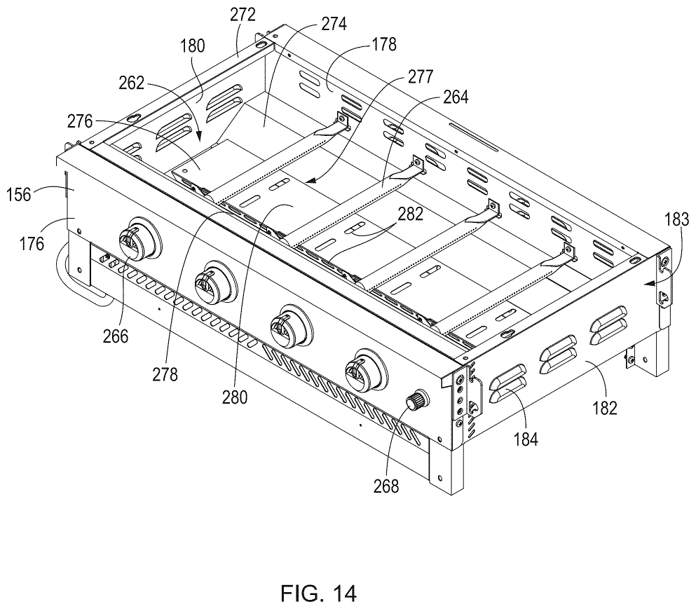

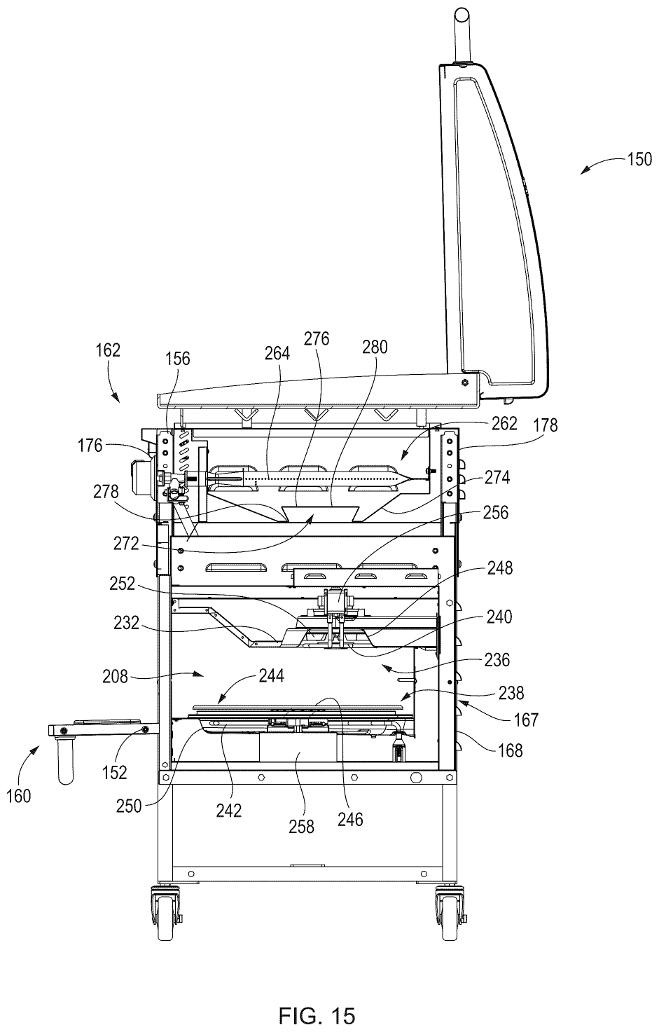

With reference to FIGS. 12, 14 and 15, in one embodiment, the first spaced gap 209 may be an air-space that may include various dimensions between the cooking chamber structure 202 and the secondary heat shield 200. In another embodiment, the first spaced gap 209 may include an insulation material 213 (such as fiber glass type insulation) to fill a majority of the first spaced gap 209. The combination of the first spaced gap 209 being filled with the insulation material 209 and the secondary heat shield 200 both surrounding the first heat shield or the cooking chamber structure 202 may provide advantageous heat retention for the cooking chamber 208 of the oven portion 152. Further, the external wall structure 167 may be positioned to partially surround the secondary heat shield 200 so as to define a second spaced gap 211. The second spaced gap 211 may include various dimensions alongside various sides of the secondary heat shield 200. For example, the external wall structure 167 may at least partially surround the secondary heat shield 200 such that the second spaced gap 211 may be defined between the right barrier 172 of the external wall structure 167 and the ride side 216 of the secondary heat shield 200. This portion of the second spaced gap 211 may be much larger than the portion of the second spaced gap 211 defined between the left barrier 170 of external wall structure 167 and the left side 214 of the secondary heat shield 200. In another embodiment, some portions of the second spaced gap 211 may include an insulation material therein, such as fiber glass type insulation. Further, the second cooking portion 158 or griddle device 156 may include a bottom panel 276 (FIG. 14), in which the second spaced gap 211 may extend along and be defined between the upper side 218 of the secondary heat shield 200 and the bottom panel of the griddle device 156. With this arrangement, the first spaced gap 209 defined between the cooking chamber structure 202 and the secondary heat shield 200 as well as the second spaced gap 211 defined between the secondary heat shield 200 and the external wall structure 167 as well as the lower panel 276 of the griddle device 156 may minimize the unwanted heating of functional components of the cooking station 150 as well as external surfaces of the cooking station 150. In this manner, the cooking chamber structure 202 and the secondary heat shield 200 (and the insulation material 213 therebetween) may each act as a heat shield to minimize heating of functional components and various portions of the cooking station 150 as well as act for heat retention of the oven portion 152 of the cooking station 150.

With reference to FIGS. 12, 13, and 15, similar to the previous embodiments described above, the cooking chamber 208 may define an upper portion 236 and a lower portion 238. The cooking chamber 208 may include an upper heating element 240 positioned within the upper portion 236 and a lower heating element 242 positioned in the lower portion 238 of the cooking chamber 208. Both the upper and lower heating elements 240, 242 may be configured to radiate heat towards a plate 246 having a cooking surface 244, the upper and lower heating elements positioned respectively above and below the plate 246. Further, the cooking chamber 208 may also include a crumb tray 260 positioned below the plate 246 and sized and configured to be manually removable from the cooking chamber 208, and may be sized to catch crumbs from below a periphery of the plate 246. Further, the plate 246 may be sized and configured to support and hold thereon a container type structure, such as a wire basket, similar to tray 112 of FIG. 7, set forth herein.

The plate 246 may be circular and extend with a flat surface. In one embodiment, the plate 246 may be a steel material, such as carbon steel, and formed by employing a cold rolled steel forming process, or any other suitable steel forming process. In another embodiment, the steel material of the plate 246 may be a stainless steel material. In another embodiment, the plate 246 may be a pizza stone, formed from clay, ceramic, cordierite or even a blend of these materials. The upper portion 236 may also include an upper mold 248 or upper concave structure that may be positioned adjacent the upper wall 232 of the cooking chamber structure 202 such that the concave structure faces downward toward the plate 246. The upper mold 248 may be sized and configured for the upper heating element 240 to be positioned therein. Further, the upper mold 248 may exhibit a reflective material or reflective surface to facilitate reflecting heat downward toward the plate 246. Similarly, the lower portion 238 may include a lower mold 250 or a lower concave structure that may be positioned below the plate 246 and above the lower wall 230 of the cooking chamber structure 202. The lower mold 250 may be sized and configured to position the lower heating element 242 therein. The concave structure of the lower mold 250 may face upward toward an underside of the plate 246 such that the concave surface of the lower mold 250 may include a reflective material to reflect heat from the lower heating element 242 directly toward an underside of the plate 246. The oven portion 152 may also include a lower fan 252 and an upper fan 254. The lower fan 252 may be positioned above the upper heating element 240 so as to push air generated by the lower fan directly over the upper heating element 240 and towards the cooking surface 244. The upper fan 254 may be positioned above the lower fan 252 and may be configured to blow air onto a motor 256, the motor configured to activate, drive and control the lower and/or upper fans 252, 254. The upper fan 254 may be vented with upper venting structure 255 positioned above the upper fan 254 and coupled to the secondary heat shield 200. The cooking surface 244 or the plate 246 may be coupled to drive member 258 that may be in the form of a cylinder, rod or a sleeve. The drive member 258 may be configured to rotate the cooking surface 244 or the plate 246 with a motor 259 positioned within or adjacent thereto, which may allow for even cooking of a food item positioned on the cooking surface 244. Further, the lower heating element 242 may be fixedly positioned adjacent an underside of the plate 246. In one embodiment, the lower heating element 242 may extend to define a first heating portion 243 and a second heating portion 245. The first heating portion 243 may extend along to heat a first half of the underside of the plate 246 and the second heating potion 245 may extend along to heat a second half of the underside of the plate 246. The first heating portion 243 may extend with a curvature so as to extend to form a partial circle shape or about a half circle shape. In one embodiment, the second heating portion 245 may also extend with a curvature in a curved zig-zag pattern or half flower peddle pattern or a finger pattern or the like. In another embodiment, the second heating portion 245 may extend with more heating element length than the first heating portion 243. In another embodiment, the first heating portion 243 may extend along an outer radial region of the underside of the plate 246 and the second heating portion 245 may extend along an inner radial region of the underside of the plate 246. With this arrangement, as the plate rotates, the first and second heating portions 243, 245 of the second heating element 242 may be stationary so as to heat most all of the underside of the plate 246. The heat may then conduct through the plate 246 so that the cooking surface 244 of the plate 246 may cook food items positioned thereon.

With reference to FIGS. 10, 11, and 12, in another embodiment, the oven portion 152 of the cooking station 150 may be controlled with an oven control knob 161. The oven control knob 161 may be interconnected to a controller sized and configured to control the upper and lower heating elements 240, 242 as well as the lower and upper fans 252, 254. The oven control knob 161 may be configured to control the heating of such upper and lower heating elements 240, 242 with pre-programmed or pre-set controls selectable by the user at the oven control knob 161. For example, the oven control knob 161 may include an LCD screen, associated therewith, that may provide temperature detail of the cooking chamber 208. As such, the controller may be interconnected to one or more temperature sensors located at various positions within the cooking chamber 208. Further, the pre-set controls selectable with the oven control knob 161 may include a pre-determined heating procedure for baking a fresh pizza or other bread type food, for example, or another pre-set control for cooking a frozen pizza, and another pre-set control for air-frying within the cooking chamber 208, and another pre-set control for reheating food, cooking fresh pizza or frozen pizza, similar to that described for the portable oven 10 in the previous embodiment. Such pre-set controls may selectively employ the upper and/or lower heating elements 240, 242 for predetermined periods of time and for predetermined temperatures as well as selectively employ the lower fan 252 for moving or mixing air within the cooking chamber 208. Such oven control knob 161 may be interconnected with one or more processors and one or more memory, which may include programming and software designed and configured to implement the functions of the oven portion 152 of the cooking station 150, as known by one of ordinary skill in the art, similar to that described for the portable oven 10 (see FIG. 8), set forth herein. In other words, the description of the electronic controls of the control panel 66 of the portable oven 10 (see FIG. 8) set forth previously are applicable to the functionality of the control knob 161 and the electronics associated with the oven portion 152 of the cooking station 150 of this embodiment.

Now with reference to FIGS. 10 and 14, as previously stated, the griddle device 156 or the second portion 162 of the cooking station 150 will now be further described. The front, rear, left, and right panels 176, 178, 180, 182 of the second portion 162 may extend to define a burn box 183 (see also, FIG. 11). The burn box 183 may extend to define an inner portion 262. The inner portion 262 of the burn box 183 may include multiple elongated burners 264 extending between the front panel 176 and the rear panel 178. The front panel 176 may also include controls, such as burner knobs 266 and an igniter 268. The burner knobs 266 and igniter 268 may be configured to control gas flow through the burners 264 and ignite fuel, such as propane or natural gas. The griddle device 156 may include a griddle 270 configured to be positioned over and supported by the burn box 183 so as to be positioned above the multiple elongated burners 264 and adjacent an upper periphery 272 of the burn box 183. The griddle 270 may extend with a flat cooking surface. In other embodiments, the second cooking portion 158 may include structure for suspending a grate or grill structure. Each of the burner knobs 266 may include the appropriate valves and components associated therewith configured to control gas being supplied to the gas burners or elongated burners 264, as known to one of ordinary skill in the art. Further, although only some of the primary components for operating the elongated burners 264 and the ignitor 268 for operating the upper cooking portion or griddle device 156 are described herein, the remaining components that may be needed for proper functioning of the cooking station 150 may be incorporated herewith, as known by one of ordinary skill in the art. Further, a similar griddle portion or griddle device is described in multiple embodiments of commonly assigned U.S. patent application Ser. No. 17/887,024, filed Aug. 22, 2022, entitled “OUTDOOR COOKING STATION WITH MULTIPLE INDEPENDENT COOKING MODES AND METHOD THEREOF,” the disclosure of which is hereby incorporated by reference herein in its entirety.

With reference to FIGS. 10, 14, and 15, the inner portion 262 of the burn box 183 may include angled panels 274 positioned below the multiple elongated burners 264. The angled panels 274 may be coupled to the front panel 176 and the rear panel 178 and may extend inward and slope downward towards one another at an angle. The angled panels 274 may extend at an angle towards the first portion 160 of the cooking station 150. The burn box 183 may also include the before described lower panel 276 that may also extend to define a lower ventilation portion 277 that may be coupled to the angled panels 274. The lower ventilation portion 277 may extend upwards from the angled panels 274 defining vertical components 278 and horizontal component 280, each of which may be formed from sheet metal. The vertical components 278 and the horizontal component 280 may extend with ventilation openings 282 therein for ventilation since the lower panel 276 may be positioned above the oven portion 152 of the cooking station 150. The horizontal component may include upper and lower horizontal components, the lower horizontal component may not include ventilation openings and the upper horizontal component may include the ventilation openings 282. The lower horizontal component may extend as a panel above the oven portion and act as a heat shield and the ventilation openings in the upper horizontal components as well as the vertical components facilitate minimizing heat from the oven portion 152 positioned below the lower horizontal component. In this manner, the lower panel 276 and the lower ventilation portion 277 may act as a heat shield relative to heat from the oven portion 152 as well as structure for cooling off the lower panel 276.

The lower ventilation portion 277 may be configured to direct heat and warmed air from below the multiple elongated burners 264 out from under the second portion 162. The vertical and horizontal components 278, 280 may include multiple ventilation openings 282 defined therein. On the horizontal component 280, the ventilation openings 282 may be positioned directly below the multiple elongated burners 264 such that the openings 282 may not be within the line of sight or a direct line between the gas flame of the burners 264 and the openings 282. Such openings 282 being mis-aligned with the gas flame of the burners 264 may prevent direct radiation heat from readily moving through the openings 282 to heat structure through the openings 282, thereby, minimizing heating of the structure below the upper horizontal component. Further, the lower ventilation portion 277 may be coupled to the angled panels 274 extending upwards and above the angled panels 274. The angled panels 274 may direct heat and air flow towards the multiple outlets 282 defined on the vertical panels 278 of the lower ventilation portion 276. As such, the lower ventilation portion 277 with its openings 282 defined therein may assist in minimizing the heating of the upper cooking portion or the lower structure of the burn box 183 from heat of the oven portion 152 of the cooking station 150.

The various structural components of the embodiments of the portable oven 10 as well as the cooking station 150 set forth herein may be formed from metallic materials, such as stainless steel, aluminum, copper, or any other suitable metallic material, as well as any other materials needed to form and manufacture the various components of the oven portion 10 or cooking station 150, such as high temperature rated polymeric materials, as known by one of ordinary skill in the art. Further, the structural components of the portable oven 10 or cooking station 150 may be formed by employing known manufacturing techniques and processes, such as welding, molding, milling, drilling, bending, fastening, soldering, etc., as known to one of ordinary skill in the art.

While the invention may be susceptible to various modifications and alternative forms, specific embodiments have been shown by way of example in the drawings and have been described in detail herein. Further, the structural features of any one embodiment disclosed herein may be combined or replaced by any one of the structural features of another embodiment set forth herein. However, it should be understood that the invention is not intended to be limited to the particular forms disclosed. Rather, the invention includes all modifications, equivalents, and alternatives falling within the spirit and scope of the invention as defined by the following appended claims.

What is claimed is:

1. An outdoor cooking station configured to simultaneously and independently cook food with separate cooking modes, the outdoor cooking station comprising:
a main body extending to define a griddle portion and an oven portion, the griddle portion including a griddle member supported by the main body and positioned above one or more gas flame burners, the oven portion positioned below the griddle portion, the oven portion including multiple panels positioned to define a cooking chamber with an access member positioned along a front side of the cooking chamber, the access member configured to be moveable between open and closed positions, the cooking chamber including a lower electrical heating element, a plate, an upper electrical heating element, and a fan, the lower electrical heating element positioned below the support member and the upper electrical heating element positioned above the plate with the fan positioned above the upper electrical heating element such that the fan is configured to move air over the upper electrical heating element and mix the air within the cooking chamber.

2. The outdoor cooking station of claim 1, wherein the multiple panels act as a first heat shield relative to an exterior wall structure of the main body.

3. The outdoor cooking station of claim 2, further comprising a secondary heat shield, the secondary heat shield at least partially positioned between the exterior wall structure and the multiple panels that define the cooking chamber.

4. The outdoor cooking station of claim 2, further comprising a secondary heat shield and an insulation material, the secondary heat shield configured to at least partially surround the first heat shield with the insulation material positioned between the secondary heat shield and the first heat shield.

5. The outdoor cooking station of claim 1, wherein the plate extends to define a flat cooking surface of the oven portion.

6. The outdoor cooking station of claim 1, wherein the plate is configured to support a basket type container thereon, the basket type container configured to hold food therein and configured to be positioned within the cooking chamber and removed from the cooking chamber.

7. The outdoor cooking station of claim 1, wherein the main body defines storage structure positioned along one side of the multiple panels of the cooking chamber.

8. The outdoor cooking station of claim 1, further comprising an upper fan configured to cool the motor of the fan positioned adjacent the upper electrical heating element.

9. The outdoor cooking station of claim 1, further comprising a lower ventilation portion positioned below the gas flame burners, the lower ventilation portion positioned above an upper venting portion of the oven portion.

10. An outdoor cooking station configured to simultaneously and independently cook food with separate cooking modes, the outdoor cooking station comprising:
a main body extending with a framework and panels positioned to define a front side, a rear side, a left side and a right side, the main body including one or more gas flame burners controlled along the front side and coupled to the main body;
a griddle portion of the main body, the griddle portion including a griddle supported by an upper side of the main body, the griddle positioned above the one or more gas flame burners of the main body;
an oven portion of the main body, the oven portion positioned directly below the griddle portion of the main body, the oven portion defined with the framework and the panels of the main body, the oven portion including chamber panels defining a chamber of the oven portion, the oven portion including:
a lower electrical heating element;
a plate positioned above the lower heating element, the plate including a flat cooking surface;
an upper electrical heating element positioned above the plate; and
a fan positioned above the upper electrical heating element, the fan configured to move air over the upper heating element and configured to mix air within the chamber;
wherein the lower and upper electrical heating elements are associated with and controlled by a control knob positioned along a front side of the oven portion.

11. The outdoor cooking station of claim 10, wherein the oven portion comprises two heat shields surrounding the chamber and separated with a spaced gap to minimize temperature of an exterior surface of the panels of the main body.

12. The outdoor cooking station of claim 11, wherein the two heat shields comprise an insulation material positioned within the spaced gap between the two heat shields.

13. The outdoor cooking station of claim 10, wherein the plate is configured to support a basket type container thereon, the basket type container configured to hold food therein and configured to be positioned within the chamber and removed from the chamber.

14. The outdoor cooking station of claim 10, wherein the main body defines storage structure positioned along one side of the chamber.

15. The outdoor cooking station of claim 10, wherein the oven portion further comprises an upper fan configured to cool the motor of the fan positioned adjacent the upper electrical heating element.

16. The outdoor cooking station of claim 10, further comprising a lower ventilation portion positioned below the gas flame burners, the lower ventilation portion positioned above an upper venting portion of the oven portion.

17. The outdoor cooking station of claim 10, wherein the oven portion comprises a front door pivotably coupled to chamber panels to facilitate access to the chamber of the oven portion.

18. A method for cooking food in the outdoors, the method comprising:
providing a main body extending with a framework and panels positioned to define a front side, a rear side, a left side and a right side, the main body including one or more gas flame burners controlled along the front side and coupled to the main body, the main body including a griddle portion and an oven portion, the griddle portion including a griddle supported by an upper side of the main body, the griddle positioned above the one or more gas flame burners of the main body, the oven portion positioned directly below the griddle portion of the main body, the oven portion defined with the framework and the panels of the main body, the oven portion including chamber panels defining a chamber of the oven portion, the oven portion including a lower electrical heating element, a plate positioned above the lower electrical heating element, the plate including a cooking surface, an upper electrical heating element positioned above the plate, and a fan positioned above the upper electrical heating element, the fan configured to move air over the upper electrical heating element and configured to mix air within the chamber;
opening an access member to position food over the cooking surface of the plate and closing the access member to enclose the food within the chamber of the oven portion;
heating the chamber with at least one of the lower electrical heating element and the upper electrical heating element; and
heating the griddle of the griddle portion with the gas flame burners for cooking other food on the griddle while simultaneously cooking the food positioned over the cooking surface of the plate within the chamber of the oven portion.

19. The method according to claim 18, further comprising rotating the plate while heating the chamber to assist in even cooking of the food positioned over the plate in the chamber of the oven portion.

20. The method according to claim 18, wherein the heating the chamber comprises controlling the heating with pre-set controls selectable from a control knob along an external surface of the oven portion of the main body.

21. The method according to claim 18, wherein the heating the chamber comprises mixing air within the chamber with the fan.

22. The method according to claim 18, wherein the heating the chamber comprises retaining heat in the chamber with insulation material positioned around the panels defining the chamber and with a heat shield at least partially surrounding the insulation material.

23. A portable oven with multiple cooking modes, the portable oven comprising:
a main body extending to include a front side wall, a rear side wall, a left side wall, and a right side wall each extending to an upper side wall and lower side wall, the main body extending to define a cooking chamber therein, the front side wall including a front door positioned thereon configured to provide access to the cooking chamber;
a plate positioned within the cooking chamber, the plate including a flat cooking surface and configured to rotate within the cooking chamber;
an upper electric heating member and lower electric heating member positioned within the main body, the upper electric heating member positioned adjacent an upper side of the cooking chamber and the lower electric heating member positioned below the plate; and
a fan positioned between the upper side wall and the upper electric heating member, the fan configured to mix air within the cooking chamber and to move air through the upper electric heating member.

24. The portable oven of claim 23, wherein the flat cooking surface of the plate is a metal surface.

25. The portable oven of claim 23, wherein the flat cooking surface of the plate is a cast iron surface.

26. The portable oven of claim 23, wherein the upper side wall of the main body includes an upper door positioned thereon, the upper door positioned against one end of the front door, upon the front door and the upper door being in the closed position.

27. The portable oven of claim 26, wherein, upon the front door being in an open position, the front side of the main body defines a first chamber opening size, and wherein, upon the front door and the upper door being in an open position, the front side and the upper side of the main body defines a second chamber opening size, the second chamber opening size being larger than the first chamber opening size.

28. The portable oven of claim 23, further comprising a tray with an upstanding side wall, the tray sized and configured to be positioned on the flat cooking surface of the plate.

29. The portable oven of claim 23, further comprising a wire basket configured to be positioned within the tray.

30. The portable oven of claim 23, further comprising a crumb tray, the crumb tray removable from the main body and positionable adjacent the lower side wall of the main body.

31. The portable oven of claim 23, wherein, upon the portable oven being in a pizza oven mode, at least one of the upper and lower electric heating members are activated to heat the cooking chamber and, upon the portable oven being in an air frying mode, the upper electric heating member and the fan are activated to heat the cooking chamber.
